(19) United States
(12) Patent Application Publication
(10) Pub. No.: US 2008/0092610 A1
(43) Pub. Date: Apr. 24, 2008

(54) Protective lock structure

(76) Inventors: Chung-Yi Kuo, Sinjhuang City (TW); Kuo-Tso Wang, Sinjhuang City (TW)

Correspondence Address: TROXELL LAW OFFICE PLLC, SUITE 1404, 5205 LEESBURG PIKE, FALLS CHURCH, VA, 22041, US

(21) Appl. No.: 11/583,975

(22) Filed: Oct. 20, 2006

(51) Int. Cl. E05B 45/06

(52) U.S. Cl. 70/264

(57) ABSTRACT

A protective lock structure mainly including a main body, interior of which is disposed a control circuit assembled from a microprocessor, a memory, a high frequency transmitter circuit. The main body is connected to monitoring equipment, including an infrared camera, an infrared hot body sensing component, a sound pickup and speakers. Moreover, the main body is connected to an electric controlled lock, thereby enabling a cellular phone handset to dial out a telephone number and preset code, which the control circuit of the main body identifies and compares to ensure correctness before unlocking the electric controlled lock, thus providing a lock device with even greater safety and protective effectiveness.

### BACKGROUND OF THE INVENTION

(a) Field of the Invention

The present invention relates to a protective lock structure, and more particularly to a protective lock structure that integrates future mobile communication, using a cellular phone handset to control unlocking, and is further provided with video and sound functionality and utility for real time video information transmission to electronic mailboxes.

(b) Description of the Prior Art

Regarding current existing lock device structures, apart from the traditional lock device that uses a key to unlock and lock the lock device, other lock devices include: combination locks, card lock devices, and so on. However, regardless of the type of lock device, the unlocking structure of each is exposed to the exterior, such as a keyhole, a card swipe device, and so on, which present an opportunity that can be exploited by burglars. Hence, shortcomings exist in the safety aspect of such traditional lock devices. Furthermore, some lock devices are connected to a complete security system, wherein the majority of such lock devices are wire connected to the complete security system, and are thus subject to restrictions imposed by telephone wires, network modem wires, electric cables, signal wires, and so on, used in various types of wired transmission equipment. Hence, such prior art lock devices have shortcomings, including difficult installation of traditional monitoring equipment, high installation costs, multifarious equipment, and so on, and are easily subjected to locality restrictions. Moreover, wired transmission is easily damaged and compromised, and is thus not an ideal configuration.

### SUMMARY OF THE INVENTION

A primary objective of the present invention is to provide a protective lock structure for a lock device that eliminates the need for any unlocking structure, such as a keyhole, a card swipe device, and so on, which can be damaged and compromised, thereby increasing the safety aspect of the lock device. Moreover, monitoring equipment connected to the lock device are not subject to locality restrictions, and are not affected by limitations imposed by wired transmission. Hence, the present invention achieves enabling a cellular phone handset to control the lock device, and provides effectiveness of having video and sound functionality that enable instantaneous transmission of video and sound information to electronic mailboxes.

In order to achieve the aforementioned objective, the protective lock structure of the present invention comprises a main body, interior of which is disposed a control circuit assembled to comprise microprocessor, a memory, a high frequency transmitter circuit. The main body is connected to monitoring equipment, including an infrared camera, an infrared hot body sensing component, a sound pickup and speakers. Moreover, the main body is connected to an electric controlled lock, thereby enabling a cellular phone handset to dial out a telephone number and preset code, which the control circuit of the main body identifies and compares to ensure correctness before unlocking the electric controlled lock, thus providing a lock device with even greater safety and protective effectiveness. Furthermore, the present invention is provided with video and sound functionality that enables real time video information backup to electronic mailboxes, as well as real time receiving of alarm messages transmitted by the remote video and sound monitoring equipment that enable remote video monitoring and listening in on sounds of the monitoring site, thereby providing lock devices with extensive application in various door locks, including a household, an office, a factory, a store, as well as garage locks, and so on.

When the aforementioned monitoring equipment are set up at a site and arranged as a security system, and after the infrared hot body sensing component and video filming function of movement detection are switched on, a person intruding the monitoring area of the monitoring equipment triggers an alarm from the infrared hot body sensing component, whereupon the monitoring equipment transmits the site video pictures to each telephone preset to receive the alarm.

A SIM (Subscriber Identity Module) card is located within the main body of the aforementioned protective lock structure corresponding to that of a cellular phone, and the SIM card can be freely changed without affecting settings.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows an elevational view according to the present invention.

FIG. 2 shows a circuit block diagram according to the present invention.

FIG. 3 shows an embodiment of the present invention in use.

### DETAILED DESCRIPTION OF THE PREFERRED EMBODIMENTS

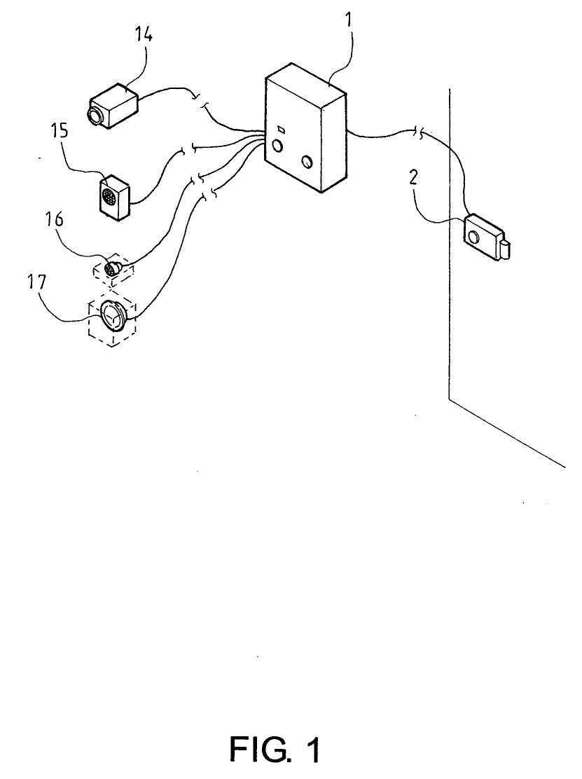

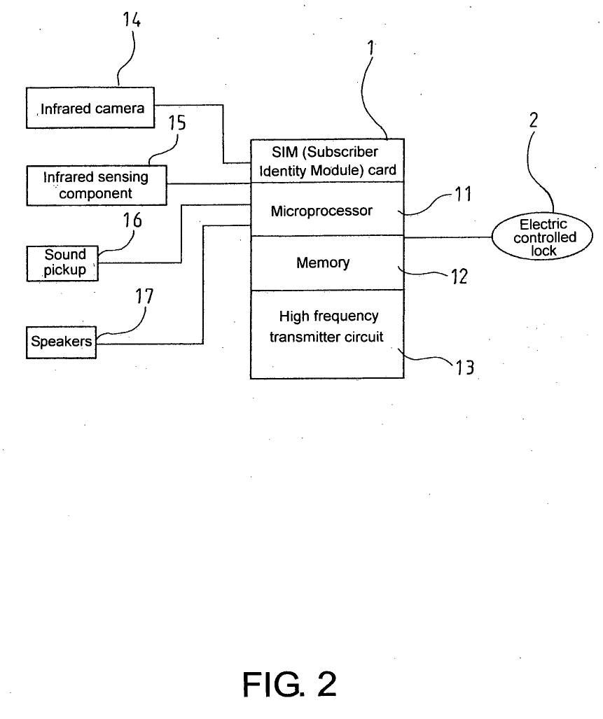

Referring to FIGS. 1 and 2, which show a main body 1 of the present invention, interior of which is disposed a control circuit assembled to comprise a SIM (Subscriber Identity Module) card 10, a microprocessor 11, a memory 12 and a high frequency transmitter circuit 13 (having GPRS (General Packet Radio Service), MMS (Multimedia Message Service), SMS (Short Message Service) functionality). The main body 1 is connected to monitoring equipment, including an infrared camera 14, an infrared hot body sensing component 15, a sound pickup and speakers 17 (moreover, the aforementioned monitoring equipment and the main body 1 form an integral body). Furthermore, the main body 1 is connected to an electric controlled lock 2 (an anode lock, a cathode lock, an electromagnetic lock, and so on), thereby fabricating a protective lock 100 that enables a cellular phone handset 3 to dial out a telephone number and preset code, which the control circuit of the main body 1 identifies and compares to ensure correctness before unlocking the electric controlled lock 2, thus providing a lock device with even greater safety and protective effectiveness. The monitoring equipment set up at the site, including the infrared camera 14, the infrared hot body sensing component 15, the sound pickup 16 and the speakers 17, enable remote video monitoring and listening in on sounds of the site, thereby providing lock devices with extensive application in various locations, including a household, an office, a factory, a store, and so on. Moreover, the present invention lacks any unlocking structure (such as a keyhole, a card swipe device, and so on) which would allow improper prizing open and forceful entry, thereby further increasing protective effectiveness.

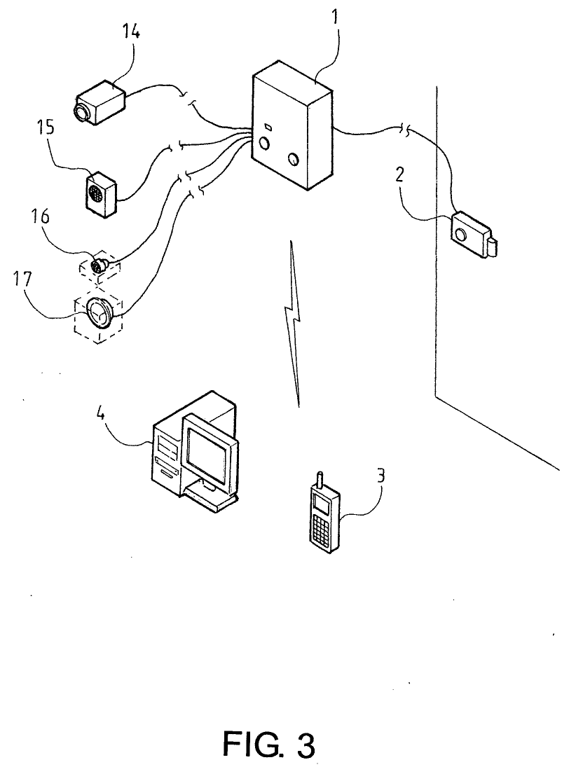

Referring to FIG. 3, which shows the present invention in use, wherein the electric controlled lock 2 is installed at an entrance door or a location requiring protection, and the monitoring equipment is installed indoors and outdoors at locations that need monitoring and where signal reception of the handset is good. Angle of each of the monitoring equipment is adjusted to align a lens of the monitoring equipment with the area requiring monitoring, and telephone numbers and electronic mailboxes that will receive the alarm and video pictures are set up. Video pictures of the location filmed by the camera 14 are transmitted to a first electronic mailbox set up in the cellular phone handset 3 of a user or a computer 4 by means of the high frequency transmitter circuit 13, which cause the cellular phone handset 3 of the user to emit speech sounds that are broadcasted by the speakers 17, thereby producing a startling effect. Moreover, when the user is out and a visitor calls, the visitor is able to communicate with the remote user using the sound pickup 16, thereby providing the protective lock with greater practical value.

The user is able to use either a phone call or a SMS message to take the initiative and request checking the monitoring site. When using a phone call to check up, the user only needs to dial the SIM card number located within the main body 1, and after a connection is made with the main body 1, the monitoring equipment is able to automatically identify the calling telephone number, whereafter it hangs up and transmits video pictures of the monitoring site to the first electronic mailbox set up in the handset 3 or the computer 4 of the user. When a SMS message is used to check up on the monitoring site, after the monitoring equipment receives contents of the transmitted SMS message, then the monitoring equipment transmits relevant video pictures to the handset 3 and an electronic mailbox according to instruction requests of the user.

When the user is outdoors and wishes to listen in on the monitoring site situation, then the user can transmit a SMS message having “T+telephone number or handset number” format, and within one minute the monitoring equipment dials the dialed telephone number after the T instruction character, and after the user receives the call from the monitoring equipment he is able to listen to sound being transmitted from the monitoring site.

When the aforementioned monitoring equipment are set up at a site and arranged as a security system, and after the infrared hot body sensing component 15 and video filming function of movement detection are switched on, a person intruding the monitoring area of the monitoring equipment triggers an alarm from the infrared hot body sensing component 15, whereupon the monitoring equipment transmits the site video pictures to each telephone preset to receive the alarm, whereafter the telephone numbers are loop dialed until a certain telephone receives the call or refuses to receive the call, whereupon the loop dialing is halted, otherwise loop dials a number of times, but if time interval separating each alarm is less than 10 minutes, then the monitoring equipment only transmits site video pictures and will not dial the telephone numbers to prompt a notification.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A protective lock structure, comprising a main body, interior of which is disposed a control circuit assembled to comprise a SIM (Subscriber Identity Module) card, a microprocessor, a memory and a high frequency transmitter circuit; an electric controlled lock connected to the control circuit of the main body, and the control circuit controls unlocking of the electric controlled lock; an infrared camera connected to the main body, which enables filming of video that is transmitted to a receiver device set up by a user through the high frequency transmitter circuit; an infrared hot body sensing component connected to the main body, which enables detecting movement of persons, thereby triggering a signal that actuates the control circuit to automatically emit an alarm, a sound pickup connected to the main body, which enables picking up sound signals; speakers connected to the main body, which enable broadcasting of sound signals recorded or picked up by the control circuit of the main body.

2. The protective lock structure according to claim 1, wherein the SIM card within the main body corresponds to that of a cellular phone of a user, and the SIM card is freely changed without affecting settings.

3. The protective lock structure according to claim 1, wherein the electric controlled lock connected to the control circuit of the main body is a lock device, including an anode lock, a cathode lock, an electromagnetic lock.

4. The protective lock structure according to claim 1, wherein monitoring equipment, including the infrared camera, the infrared hot body sensing component, the sound pickup and the speakers are separably connected to the main body or assembled as an integral body.
